(19) United States
(12) Patent Application Publication
(10) Pub. No.: US 2008/0140804 A1
(43) Pub. Date: Jun. 12, 2008

(54) DEVICE FOR CONTROLLING IP COMMUNICATIONS BETWEEN IP COMMUNICATION EQUIPMENT, WITH AUTOMATIC CONTROL OF THEIR MEDIA FLOWS

(76) Inventor: Jerome Wagner, Paris (FR)

Correspondence Address: CHRISTIE, PARKER & HALE, LLP, PO BOX 7068, PASADENA, CA, 91109-7068, US

(21) Appl. No.: 11/951,237

(22) Filed: Dec. 5, 2007

(30) Foreign Application Priority Data
Dec. 11, 2006 (FR) 06/10766

(51) Int. Cl. G06F 15/16

(52) U.S. Cl. 709/217

(57) ABSTRACT

A device (D) is dedicated to controlling IP communications between at least two communications apparatus (E1, E2) capable of exchanging IP data packages, generated by at least one type of medium, through at least one communications network (RC). This device (D) comprises control means (MC) adapted to be installed in a server (S) and tasked with i) initiating, on demand, the transmission of files to be executed to communications apparatus (E1, E2), these files being intended, once executed by a communications apparatus (E1), to allow, on the one hand, automatic registration with the server (S) of the user of this communications apparatus (E1) and, on the other hand, the controlling in said communications apparatus (E1) of each flow generated by a medium to which access has been authorised by its user, and ii) in the case of registration with the server (S) of at least two users wishing to establish an IP communication between them, organising the relaying and management of the permitted flows between the communications apparatus (E1, E2) of these users throughout the duration of the IP communication.

The invention relates to the field of communications through an internet protocol communications network (or IP network), also referred to as “IP communications” and more precisely the controlling of such communications between communications apparatus capable of exchanging IP data packets generated by at least one type of medium.

By “communications apparatus” is meant here any type of data processing equipment provided with (possibly multimedia) communication means which enables it to establish IP communications via a wired or wireless communications network, optionally of the (fixed or mobile) telephone network type. It may therefore be, for example, an optionally portable (micro-)computer, an IP telephone, optionally mobile, or a personal digital assistant (or PDA) with communications facility and generally any kind of terminal connected to an IP network.

Moreover, the term “media” refers here to any kind of media capable of supplying data of any type which can be exchanged between equipments (or entities) which have established a communications channel between them, and particularly audio data, video data, data files to be transferred, so-called instant messaging data (or chat) or so-called electronic messaging data (or e-mail).

As is well known to the skilled man, for (communications) equipment to be able to establish IP communications its user has to download software dedicated to this purpose onto the equipment from the internet. Then he has to run this dedicated software and then, in the majority of cases, set up an account on a dedicated server, registering under a pseudonym, and then inform every user with whom he wishes to establish an (optionally multimedia) IP communication, for example by means of a telephone call or by sending an electronic message (SMS, MMS or e-mail), in order to provide them with the co-ordinates of the dedicated server and his pseudonym. Then, each user duly informed has in turn to download and run the dedicated software and then set up an account on the dedicated server, registering under a pseudonym, and provide their pseudonym to the user who wishes to establish communication with them, for example by another telephone call or by sending a new electronic message (SMS, MMS or e-mail). Then, the users have to configure their respective equipments, by means of their dedicated software, in order to be able to exchange data flows of at least one kind (such as audio [supplied for example by the microphone of the equipment or an auxiliary microphone] and/or video [for example supplied by an add-on peripheral such as a camera (webcam)]).

Owing to the large number of steps currently needed to set up IP communication, many people refuse this type of communication in spite of the advantages, particularly financial, which it provides.

The invention thus sets out to improve the situation and particularly to reduce substantially the number of steps needed to set up an IP communication while simplifying these reduced steps.

For this purpose it proposes a device dedicated to controlling IP communications established between at least two communications apparatus capable of exchanging IP data packages (generated by at least one type of medium) through at least one (communications) network.

This control device is characterised in that it comprises control means intended to be installed in at least one server having an IP address and tasked with:
initiating, on demand, the transmission of files to be executed to communications apparatus, these files being intended (once executed by a communications apparatus) to allow on the one hand automatic registration, with the server, of the user of this communications apparatus (in order for example to indicate that they are prepared to participate in an IP communication, or that they would like a list of other registered users sent to them, or that they wish to establish an IP communication with at least one other registered user), and on the other hand taking control, in the communications apparatus, of each flow generated by a medium to which access has been authorised by its user, and
in the case of registration with the server by at least two users (for example at least two people, or at least one person and at least one virtual user) wishing to establish IP communication between them, organising the relaying and management of the permitted flows between their communications apparatus for the entire duration of the IP communication.

The device according to the invention may have other features which can be taken separately or in combination, particularly:
its files may be arranged, once executed, so as to take control of flows generated by media selected from among audio, video, data file transfer, instant messaging and electronic messaging;
its files may be arranged, once executed in a communications apparatus, so as to organise on the one hand the establishment of a two-way communications channel, via the IP network, between this communications apparatus and the server, and on the other hand the transmission to the control means, via the communications channel, of data suitable to allow them to register the user of this communications apparatus and every type of media to which access has been granted by the user;
   its files may be arranged, once executed in a communications apparatus and when the user of the latter cannot establish an IP communication with another user because he is not registered with the server, so as to enable the user to send a message intended for this other user to the server via the communications channel established. In this case, when the other user registers with the server, the control means are tasked with notifying this other user of the existence of the message intended for him;
its control means may be tasked, when a user is registered with them, with storing in the server data that a representative of an operation which they will have to carry out if another registered user seeks to set up an IP communication with this user, but that the latter is deregistered;
   the operation is for example chosen from the transfer of a call to a given communication identifier, and the furnishing to another user of a message previously registered by an unregistered user and stored in the server;
its files may be arranged, once they have been executed in a communications apparatus, to allow their user to define at least one filter which is intended to select certain users from all those registered, in accordance with at least one selected criterion. Thus, the user can select from among the selected users every registered user with whom he wishes to establish an IP communication via the server;
its files may be arranged, once they have been executed in a communications apparatus and when an IP communication has been established with at least one other user, so as to allow the user of this communications apparatus to select a new medium to which he is allowing access or to deselect a medium to which he had allowed access;
it may comprise management means coupled to the control means, intended to be installed in at least one server and tasked with managing the costing and/or billing of operations carried out by at least one of the users who are involved in an IP communication (through the server), in accordance with a selected scale of charges, and/or the authorised duration of an IP communication (through the server) as a function of at least one selected criterion, and/or the billing of an IP communication (through the server) to at least one of the users who are involved in an IP communication, in accordance with a selected scale of charges.

The invention also proposes an internet server, for an IP network, which is equipped with a control device of the type described hereinbefore.

Further features and advantages of the invention will become apparent from a study of the detailed description that follows, and the attached drawings, wherein:

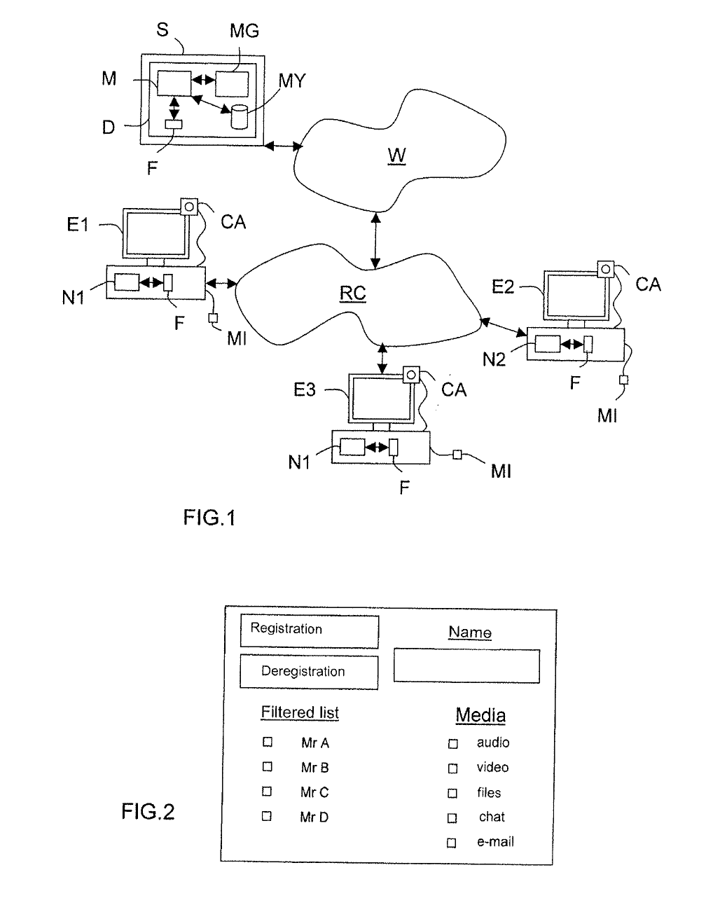

FIG. 1 is a highly schematic functional illustration of a communications installation comprising an internet server equipped with one embodiment of a control device according to the invention, and

FIG. 2 is a highly schematic illustration of an example of a display window which allows a user i) to select the medium or media to which he is allowing access and the user or users with whom he wishes to establish an IP communication, and ii) to register or deregister.

The attached drawings may serve not only to complete the invention but may contribute to its definition, if applicable.

The invention sets out in particular to enable users of IP communications apparatus to establish IP communications between them in a simple and rapid manner and with a greatly reduced number of steps (or operations).

In the following description and as shown in FIG. 1, as a non-restrictive example the communications apparatus Ei (here, i=1 to 3) of the users are microcomputers equipped with a communications module capable of establishing IP communications via a communications network RC, for example a wired network (optionally of the XDSL or cable type) in order to exchange IP data packages generated by at least one type of medium. For example, and as shown in the drawings, each microcomputer is equipped with two peripheral accessories, one supplying audio-type data (such as a microphone MI, for example) and the other delivering video-type data (such as for example a camera (or webcam) CA).

However, the invention is not limited to this type of IP communications apparatus. It relates in effect to all types of data processing equipment provided on the one hand with communication means (optionally of the multimedia type) which allows it to establish IP communications, via a wired or wireless communications network, optionally of the (fixed or mobile) telephone network type, and on the other hand an internet navigator (or browser) Nj (here j=1 or 2 to indicate different types, as non-restrictive examples). It may thus also be, for example, a portable microcomputer, an IP telephone, optionally mobile, or a personal digital assistant (or PDA) with a communications facility. The invention relates to any type of internet browser Nj, particularly Windows, GNU/Linux and MacOS X.

For example the invention is not limited to IP communications apparatus (hereinafter referred to as “apparatus” for short) provided with an audio medium (MI) and a video medium (CA). In fact, the invention is applicable if the apparatus Ei has at least one medium generating data to be transmitted of whatever kind (audio, video, transfer files, instant messaging (or chat), electronic messaging (or e-mail), in particular).

Furthermore, in the description that follows it will be assumed that the users of the apparatus Ei are (physical) persons. However, this is not necessarily the case. They may in fact be virtual users such as for example robots or automatons receiving requests for action(s) coming from (physical) persons.

The invention proposes installing, in at least one internet server S, a device D charged with controlling IP communications between at least two apparatus Ei and Ei′, via a communications network RC of the IP type, which is itself connected to the internet network (or web) W.

By “communications network of the IP type” is meant here a communications network (optionally telephonic) to which Ei apparatus may be connected (by wire or by waves) and which is capable of transporting IP data packages.

The internet server S is connected to the internet network W and has an IP address.

As schematically shown in FIG. 1, the device D comprises at least one control module MC and a set of files to be executed, designated F.

The control module MC is first of all tasked with initiating, on demand, the transmission of the set of files F to communications apparatus. More precisely, every time a user wishes to register automatically with the server S, to indicate that he is prepared to participate in an IP communication or would like to establish an IP communication with at least one other user who is already registered, he has to access the server S. This access may either be done directly, i.e. by the user supplying the IP address of the server S to the internet browser Nj of his apparatus Ei, or indirectly, i.e. via an HTML-type page (HyperText Markup Language) of an internet site providing a link to the server S. In this second case the user must first of all use the internet browser Nj of his apparatus Ei to access the internet site which provides the link to the server S, then click on this link to access the server S.

The accessing of the server S by an apparatus Ei triggers, preferably automatically, the transmission of the set of files F to this apparatus Ei. Preferably, the set of files F is not selected by the control module MC as a function of the type of internet browser Nj of the requesting apparatus Ei. In other words, the set of files F may be executed by any type of internet browser Nj.

When the internet browser Nj of an apparatus Ei receives the set of files F, it automatically executes the files received (without any intervention by the user). This execution of the set of files F thus allows the browser Nj to carry out two actions.

The first action consists in automatically registering the user of the apparatus Ei with the server S in order to notify the control module MC, for example, either that this user is prepared to participate in IP communication or that he wishes to obtain a list of other registered users, or again that he wishes to set up an IP communication with at least one other user who has already been registered. It is important to note that by “register a user” is meant the fact of storing, in a memory MY of the server S, a communications identifier for his apparatus Ei (for example his IP address), optionally linked to a name or pseudonym or a characteristic design.

As diagrammatically shown in FIG. 2, when the user wishes only to indicate that he is prepared to participate in a communication, he may for example click on a dedicated icon (“Registration”) of a display window, generated by the set of files F, which is automatically displayed on the screen of his apparatus Ei. When the user has clicked on this dedicated icon, the set of files F automatically triggers the sending to the server S of a registration message containing the IP address of the apparatus Ei.

It is also possible for the user to enter his name or pseudonym (“Name”) in a dedicated zone (an empty box placed underneath the word “Name”) on the display window, before clicking on the dedicated icon (“Registration”). When the user has entered his name and clicked on the icon dedicated to registration, the set of files F automatically triggers the sending to the server S of a registration message containing the IP address of the apparatus Ei and the name of the user. It will be noted that entering the name of the user is not obligatory if the server S already has a lookup table between communications identifiers and user names. In fact, in this case, when the server S receives the registration message, its control module MC (for example) extracts from it the IP address and looks in the lookup table for the name corresponding to it.

In both cases, when the server S receives a registration message, its control module MC (for example) stores in the memory MY the name of the user registered, optionally linked to the communications identifier for his apparatus Ei. It is also possible for the control module MC (for example) to store in the memory MY only the communications identifier of the apparatus Ei of the user who is registered, but this would mean that the other users could only be sent the communications identifiers of the apparatus or that there would be a supplementary lookup table between the communications identifiers of the apparatus and the user names.

As shown schematically in FIG. 2, when the user wishes to indicate that he would like to set up communication with at least one other user who is already registered, he may for example select him from a list of registered users (“Mr A”, “Mr B”, “Mr C”, “Mr D”, . . . ) (displayed in a display window of an apparatus Ei, generated by said set of files F).

A list of registered users may be obtained by a user in different ways. Thus it may be possible to obtain a partial or complete list from an internet site, for example through a link provided in the (or a) display window generated by the set of files F. It is also possible to envisage obtaining a partial or complete list from the server S by sending it a request, for example by clicking on a dedicated icon provided in the (or a) display window generated by the set of files F. It is also possible to envisage the control module MC automatically sending a partial or complete list to an apparatus Ei following registration of its user.

The choice of each user with whom it is desired to establish a communication is made for example by clicking on the box placed next to the name of a user. Obviously, it is possible to choose a number of registered users. Then, the user may for example click on the dedicated icon (“Registration”) of the display window. When the user has clicked on this dedicated icon the set of files F automatically triggers the sending to the server S of a registration message containing the IP address of the apparatus Ei and the name of each user selected.

It is also possible to envisage the user entering his name or pseudonym (“Name”) in a dedicated zone (empty box placed underneath the word “Name”) in the display window, before clicking on the dedicated icon (“Registration”). When the user has made his choice of user(s), entered his name and clicked on the icon dedicated to registration, the set of files F automatically causes the sending, to the server S, of a registration message containing the IP address of the apparatus Ei, the name of each user selected and the name of the user.

It will be noted that the user is not obliged at this stage to choose the medium or media of his apparatus Ei which he is putting at the disposal of the desired IP communication. This choice is preferably made later, for example by clicking on the box provided against the medium made available. However, it would also be possible for it to be done at this stage.

To allow a message of registration of an apparatus Ei to be sent to the server S and also for IP data packages to be exchanged within the framework of an IP communication, the set of files F automatically organises the establishment of a two-way communications logic channel (for example of the “full duplex” type), via the IP network RC and the web W, between this apparatus Ei and the server S. It is important to note that a two-way communications channel remains in place between an apparatus Ei and the server S as long as the user of the latter is registered with the server S. Deregistration of a user takes place automatically, for example, when he closes the internet page of the site which he was visiting and which contained the link to the server S, or when the user exits the link established directly with the server S. It is also possible to envisage (as illustrated in non-restrictive manner in FIG. 2) that the set of files F should provide a deregistration icon (“Deregistration”) in a display window (possibly the one used for the registration and the selection of users and media). In this case, when the registered user of an apparatus Ei clicks on this deregistration icon, the set of files F sends a deregistration message to the server S in the two-way communications channel of the apparatus Ei.

When the server S receives a registration message containing the name of the registered user(s), its control module MC (for example) stores in the memory MY the name of the user who has registered, optionally linked to the communications identifier for his apparatus Ei. It is also possible to envisage that the control module MC (for example) would store in the memory MY only the communications identifier of the user who has registered. Then the control module MC establishes a link (or a relay) between the two-way communications channel newly established between the apparatus Ei of the user who has just registered and his server S and between the two-way communications channel established between the apparatus Ei′ of each designated user and his server S. This link or these links come down to registering the apparatus Ei and Ei′ together, at the request of the user of the apparatus Ei who is requesting that the communication be established.

It will be noted that for generating the display window or the registration message the set of files F preferably uses primitives (or functions) which are naturally pre-existing in the browser Nj of the apparatus Ei in which it is executed. For example, it uses Flash-type primitives such as “System.showSettings” and “NetStream.attachAudio( )”.

In this case it is advantageous that the files of the set F should be a combination of files in so-called SWF and JavaScript format. It will be noted that it is possible to use primitives of a type other than Flash provided that they are integrated in and comprehensible (usable) by internet browsers.

The second action permitted by the set of files F consists in taking control in an apparatus Ei of each flow generated by a medium to which access has been granted by its user. As mentioned previously, the set of files F invites the user (in a display window, preferably the same one used for the registration phase (see FIG. 2)) to choose each medium on his apparatus Ei which he is making available to the desired IP communication. In other words, the selection of a medium by the user constitutes permission to access the flows generated by this medium for at least part of the duration of the desired IP communication (i.e. for as long as the user does not decide to withdraw access authorisation to a medium).

It will be noted that in order to take control of a medium the set of files F preferably uses primitives (or functions) which naturally pre-exist in the browser Nj of the apparatus Ei in which it is executed. For example, it uses Flash-type primitives.

The designation of each medium selected by a user may be transmitted to the server S by a set of files F either in a registration message or in a dedicated message, subsequent to the sending of the registration message. When the server S receives a registration message or a dedicated message containing at least one designation of media, its control module MC (for example) configures it so that it is capable of transferring the flows of the designated media, originating from the apparatus Ei from which the message has come, to each apparatus Ei′ of a selected registered user.

The control module MC is thus also tasked with organising the relaying and management of the flows permitted between the apparatus Ei and Ei′ of registered users (through the two-way communications channels the creation of which has been organised by their respective sets of files F and by the functional choices made by the users), throughout the duration of their IP communication. It will be noted that the management of the flows comprises in particular everything relating to the notification needed to set up and maintain a two-way communications channel between an apparatus Ei and the server S.

Thanks to the invention, each user involved in an IP communication is free to select the medium or media that generate the flows he wishes to transmit. For example, if a first user selects audio media MC (microphone) and video media CA (camera) of his first equipment E1, while a second user selects only the audio medium MC (microphone) of his second equipment E2, the first equipment E1 can only broadcast through its speaker (or a plug-in headset) the audio data of the audio flow from the second equipment E2, and the second equipment E2 will be able to broadcast over its speaker (or a plug-in headset) the audio data of the audio flow from the first equipment E1 and display, on its screen, the images defined by the video data originating from the first equipment E1. As indicated previously, any type of combination of flows generated by at least one medium may be envisaged in the apparatus E1 of each user involved in an IP communication.

It is important to note that the invention also applies to IP communications of the “one to one” type (i.e. which allow all the permitted flows to be transmitted from a first apparatus Ei to a second apparatus Ei′) and to IP communications of the “one to many” type (i.e. which enable all the permitted flows to be transmitted from a first apparatus Ei to several (at least two) second apparatus Ei′, substantially simultaneously) and to IP communications of the “many to many” type (i.e. which enable all the authorised flows to be transmitted from several (at least two) first apparatus Ei to several (at least two) second apparatus Ei′, substantially simultaneously).

The set of files F may also be tasked with carrying out other operations (or actions). Thus it may for example enable a first user, who wishes to establish a communication with at least one second user who is not registered with the server S, to send the server S a message which is intended for said second user, through the two-way communications channel set up between their apparatus Ei and said server S. Such a message therefore contains the name of the unregistered user and/or the communications identifier for their apparatus Ei′ and text and/or audio data that define the contents of the message. The contents may for example suggest setting up a communication starting at a certain time on a certain date or within a certain timeframe on a certain date, or indicate that its author will not be contactable on certain dates and/or at certain times, or to suggest calling the author on his (fixed or mobile) telephone from a certain time on a certain date or within a timeframe on a certain date. The contents of the message are input (text mode) and/or recorded (audio mode) when prompted by a message generated and displayed by the set of files F when it detects that a user wishes to establish a communication with at least one unregistered user.

The contents of the message are stored by the control module MC, in a message memory in its device D or server S, linked with the name and/or IP address of the unregistered user. Thus, when a user who is hitherto unregistered registers with the server S (by means of a set of files F sent to his apparatus Ei′), the control module MC analyses the message memory to determine whether any messages are intended for this user and if so communicates the contents thereof through the two-way communications channel newly established between his apparatus Ei′ and the server S.

Alternatively or additionally, the set of files F may for example (once executed in an apparatus Ei) enable the user of the latter to define at least one user selection filter. By “filter” is meant here a software module which can be configured by a user in accordance with at least one criterion which he has chosen (preferably from a list provided by the set of files F in a display window) and intended for automatically selecting certain users from all those registered with a server S. Any kind of criterion may be used, notably a criterion of belonging to a predefined list of names (professional or private) or a criterion of belonging to a predefined list of IP addresses or a set of IP addresses corresponding to at least one particular geographical area.

Thus, when a user wishes to establish an IP communication in accordance with the invention, the set of files F that he has automatically downloaded suggests to him only the registered users that meet each filtering criterion that he has chosen, so that he has only to choose, from these filtered users, the particular user with whom he wishes to establish the IP connection, through the server S.

Alternatively or additionally, the set of files F may for example (once executed in the apparatus Ei of a first user and when this apparatus Ei communicates with the apparatus Ei′ of at least one second user) enable the first user to select at any time a new medium to which he is giving access and/or to deselect a medium to which he had up until then given access. To do this, the first user has only to click in the box assigned to the medium that he wishes to select or deselect. If the user clicks on a medium which was not selected the set of files F understands that it is authorised to take control of this new medium and hence to transfer the flows that it produces to the apparatus Ei′ of every second user involved in the IP communication. If the user clicks on a medium which had hitherto been selected, the set of files F understands that it is no longer authorised to take control of this medium and therefore immediately stops transferring the flows produced by this medium to the apparatus Ei′ of every second user involved in the IP communication.

This type of action (new selection, deselection) is accompanied by a notification between the apparatus Ei and the server S through the two-way communications channel that connects them.

It is important to note that the set of files F may optionally be arranged so as to allow a user participating in an IP communication to refuse to receive one or more types of flow. This may for example enable a person who does not wish to send flows to one or more other people (for example within the framework of a conference or a lesson) not to be disturbed by the flows which these other people wish to send him. In this case, the set of files F provides the user with a window denoting each medium that every other user proposes to use in order to transmit flows, and this user has only to select each medium in which he wishes to receive flows, for example by clicking on a box dedicated to this.

The control module MC may optionally be arranged so as to store, in an operations memory of the server S (or its apparatus D) data that represent an operation which it will have to carry out if a registered user seeks to establish a communication with a user who had been registered with it but has now deregistered.

Such an operation may for example consist in transferring the call to a given communications identifier, such as for example that of a messaging service or a voicemail in which the user who has now deregistered had previously stored a message, or a telephone on which the user who has now deregistered may be contacted in the future (this then requires coming out of the purely web environment to connect up to a telephony environment (possibly mobile).

The data that define the operation that is to be carried out are stored in the operations memory by the control module MC linked with the name and/or IP address of the deregistered user. Thus, when a first user attempts to establish an IP communication with a second user who has deregistered, the control module MC analyses the operations memory to determine whether it contains an operational definition relating to this second user and if so it carries out the operation defined.

As shown in FIG. 1, the apparatus D may also comprise a management module MG coupled to its control module MC and intended to be installed in at least one server, preferably the same one (S) as the one that contains the control module MC (although this is not essential, as the apparatus D may be distributed throughout a number of servers).

This management module MG is intended to provide a function which may be called costing. More precisely it is tasked with analysing all the IP communications flows which pass through a server S in order to allow a number of actions.

A first action may for example consist in billing all or some of the operations (or actions) carried out by at least one of the users involved in an IP communication through the server S, in accordance with a selected scale of charges. Thus, every time a selected user carries out a selected action using the keypad or mouse of his apparatus Ei, such as for example winning a chosen piece in a game of chess or draughts, he may be credited or debited with a selected amount on his account. For example, winning a pawn gives him a credit of one euro, whereas winning a queen gives him a credit of five euros. In another application, every time a user draws a circle on a white sheet he may be credited or debited with a suitable amount on his account.

A second action (which may be combined with the first) may for example consist in managing the authorised duration of an IP communication (through the server S), as a function of at least one selected criterion. In fact it may be envisaged that certain users are only allowed to communicate by IP for a predefined length of time. In this case, when the management module MG detects that such a user has established an IP communication through the server S, it triggers a timer equal to the predetermined duration to which the user is entitled and when this duration expires it orders the control module MC to terminate the IP communication for this user (data flows coming from the other user or users are no longer sent to him).

A third action (which may be combined with the first and/or second) may for example consist in billing an IP communication (through the server S) to at least one of the users who are involved in it, as a function of a selected scale of charges. This may for example enable an expert or a teacher to provide information to third parties subject to the payment of a predetermined remuneration at an hourly rate (for example one euro or five euros per minute).

The control device D according to the invention and particularly its control module MC and possibly management module MG are preferably in the form of software (or data processing) modules. However, the control module MC and the management module MG, if used, may also take the form of electronic circuits or a combination of circuits and software.

It will be noted that the invention may also be studied from the viewpoint of a process for controlling communications that may be carried out using communications apparatus and servers of the type described hereinbefore with reference to FIGS. 1 and 2.

The principle steps of this process are as follows:
in the case of access to communications apparatus Ei to a server S, through an IP communications network RC, transmitting files to be executed to this communications apparatus Ei,
then, in the event of execution of these files by the communications apparatus Ei, using said files to register the first user automatically with the server S in order to notify the latter either that he is prepared to participate in a communication or wishes to establish a communication with at least one second user who has already registered,
then, when the first user wishes to establish a communication with at least one second user who has already registered, using the executed files to assume control, in the communications apparatus Ei of the first user and in the communications apparatus Ei′ of each second user, of each data flow generated by a medium for which they have given access authorisation, and
organising the relaying and management of the authorised data flows between the communications apparatus Ei and Ei′ of the first and second users, and optionally billing the communication, in the course of its duration.

It will be noted that the invention relates to applications other than that described above, notably the sharing of notice boards, shared navigation, network games and voice control of remote applications.

The invention is not restricted to the embodiments of a communications control device, server and communications control process described above, purely by way of example, but encompasses all the variants that might be envisaged by the skilled man within the scope of the claims that follow.

1. Device for controlling IP communications between at least two communications apparatus adapted to exchange IP data packages, generated by at least one type of medium, through at least one communications network comprising: a control module adapted to be installed in at least one server having an IP address and arranged i) to initiate, on demand, transmission of files to be executed, to communications apparatus, said files once executed by one of the at least two communications apparatus, allowing automated registration with said server of a user of said one of the at least two communications apparatus and causing said control module to control said one of the at least two communications apparatus of each flow generated by a medium to which access has been authorised by its user, and ii) in the case of registration with said server of at least two users wishing to establish an IP communication between them, to organise relaying and managing of permitted flows between the at least two communications apparatus of said at least two users throughout duration of the IP communication.

2. Device according to claim 1, wherein said files are arranged, once executed, to take control of the flows generated by a medium selected from a group consisting of at least audio, video, data file transfer, instant messaging, or electronic messaging.

3. Device according to claim 1, wherein said registration with the server indicates that a user is prepared to participate in an IP communication, that the user wishes to be sent a list of other registered users, or that the user wishes to establish an IP communication with at least one other registered user.

4. Device according to claim 1, wherein the files are arranged, once executed in one of the at least two communications apparatus, to organise establishing of a two-way communications channel, via said IP network, between said communications apparatus and said server, and the transmission to said control module, via said communications channel, of data adapted to enable registration of a user of said one of the at least two communications apparatus and each type of medium to which access has been authorised by said user.

5. Device according to claim 4, wherein said files are arranged, once executed in one of the at least two communications apparatus and when the user of the one of the at least two communications apparatus cannot establish an IP communication with a second user because the second user is not registered with said server, to enable said user to send to said server, via said communications channel, a message intended for the second user, and said control module is configured to notify the second user of the existence of said message intended for the second user, when said second user registers with said server.

6. Device according to claim 4, wherein said control module is configured to store in said server data representative of an operation that is to be carried out when a second registered user seeks to establish an IP communication with a first deregistered user.

7. Device according to claim 6, wherein said operation comprises a least one call transfer to a given communications identifier, and supplying to said second user a message previously recorded by said first deregistered user and stored in said server.

8. Device according to claim 1, wherein the files are arranged, once executed in one of the at least two communications apparatus, to enable the user to define at least one filter for selecting a registered user from a list of registered users, in accordance with at least one selected criterion, so that the user can establish an IP communication with the selected user, via said server.

9. Device according to claim 1, wherein the files are arranged, once executed in one of the at least two communications apparatus and once an IP communication has been established with at least one other user, to enable the user of said one of the at least two communications apparatus to select a new medium to which the users are gaining access or to deselect a medium to which the users were granted access.

10. Device according to claim 1, further comprising a management module coupled to said control module, adapted to be installed in the server and arranged to manage at least one of costing or billing of operations carried out by at least one of the users involved in an IP communication on said server, as a function of at least one of a selected scale of charges; authorised duration of the IP communication on said server, as a function of at least one of a selected criterion; or billing of the IP communication via said server to at least one of the users involved in the IP communication, as a function of a selected scale of charges.

11. Server for a communications network comprising a control device according to claim 1.

12. Method for controlling IP communications between two communications apparatus adapted to exchange IP data packages generated by a plurality of media through a communications network, the method comprising:
providing a communications server;
transmitting a configuration file from said server to a communications apparatus;
automatically registering a user of said communications apparatus with said server by executing said configuration file on said communications apparatus;
allowing access to said communications apparatus for subsequent communications to each flow generated by a medium from the plurality of media to which access has been authorized, by executing said configuration file on said communications apparatus; and
after registration with said server of at least two users, organizing the relaying and managing of permitted flows between said at least two users throughout duration of the IP communication.

13. The method of claim 12, wherein said plurality of media includes two or more of audio, video, data file transfer, instant messaging, or electronic messaging.

14. The method of claim 12, wherein said registering a user indicates that the user is prepared to participate in an IP communication, the user wishes to be sent a list of other registered users, or the user wishes to establish an IP communication with at least one other registered user.

15. The method of claim 12, further comprising:
establishing a two-way communications channel via said communication network between said communications apparatus and said server; and
enabling registration of a second user with the server through a medium to which access has been authorised by said user.

16. The method of claim 15, further comprising:
enabling said user to send to said server a message intended for the second user; and
notifying said second user of the existence of said message, when said second user registers with said server.

17. The method of claim 15, further comprising storing in said server data representative of an operation that is to be carried out when said second registered user seeks to establish an IP communication with a first deregistered user.

18. The method of claim 12, further comprising:
enabling the user to define at least one filter for selecting a registered user from a list of registered users, in accordance with at least one selected criterion; and
establishing an IP communication between the user and the selected user, via said server.

19. The method of claim 12, further comprising enabling the user to select a new medium to which the user and at least a new user are requesting access, or to deselect a medium to which the user and the at least a new user had granted access.

20. The method of claim 12, further comprising managing at least one of:
costing or billing of operations carried out by at least one of the users involved in an IP communication on said server, as a function of at least one of a selected scale of charges,
authorised duration of the IP communication on said server, as a function of at least one of a selected criterion, or
billing of the IP communication via said server to at least one of the users involved in the IP communication, as a function of a selected scale of charges.
